(19) United States
(12) Patent Application Publication
(10) Pub. No.: US 2009/0210887 A1
(43) Pub. Date: Aug. 20, 2009

(54) Radio frequency identification business-aware framework

(75) Inventors: Keun-Hyuk Yeom, Busan (KR); Seomg-Jin Kim, Busan (KR); Tae-Woo Nam, Busan (KR); Han-Jun Kim, Busan (KR)

Correspondence Address: GWIPS;Peter T. Kwon, Gwacheon P.O. Box 72, 119 Byeolyang Ro, Gwacheon City, Gyeonggi-Do, 427-600, KR

(73) Assignee: Pusan National University Industry-University Cooperation Foundation

(21) Appl. No.: 12/320,858

(22) Filed: Feb. 6, 2009

(30) Foreign Application Priority Data
Feb. 20, 2008 (KR) 10-2008-0015287

(51) Int. Cl. G06F 3/00; H04Q 5/22

(52) U.S. Cl. 719/318; 340/10.1

(57) ABSTRACT

A Radio Frequency Identification (RFID) has developed for Business-Aware Framework (BizAF) including a BESpec to define a process of obtaining information from at least one of RFID middleware, an EPCIS, an ONS, and an EPCIS DS of an architecture component defined in EPCNetwork in developing a real-time RFID event-based application, processing and transmitting the information, in which the BESpec includes a variable declaration part for storing processing values in the middle of processing an activity, the activity being a basic unit of the work for generating the RFID business event, an activity part for defining the processes that can be combined for generating the RFID business event, and a reference specification part for defining reference information for processing in the activity.

### BACKGROUND OF THE INVENTION

1. Field of the invention

The present invention relates to an RFID (Radio Frequency Identification) Business-Aware Framework (BizAF). Particularly, the RFID BizAF supports for rapid development and management of RFID system by providing a base environment including communication technology or a communication module required in developing a real-time RFID application.

2. Description of the Prior Art

The present invention is directed to business-aware middleware platform technology for supporting radio frequency identification (hereinafter referred to as “RFID”) technology-based software development.

RFID technology is similar to barcode technology in that it becomes aware of and processes an object by using a reader to read a series of codes attached to the object. However, RFID is different from an existing barcode in that it can be sensed without coming into direct contact with an object, and can be sensed through obstacles. It can also recognize several tags at a time, and can store numerous amounts of information because it has a high-capacity memory. Based on such advantages, many fields, such as logistics management, distribution management, and situation awareness, are about to introduce RFID technology.

The EPCglobal, a noncommercial organization in charge of open standardization for RFID-related technology, currently proposes international standards called the EPCglobal Network™ (i.e. EPC Network). The EPC Network uses the Electronic Product Code™ (EPC) capable of representing information specific for an object, and thereby enables RFID technology to automatically identify an object and share information on an item in connection with the Internet. Like the concept of the Internet, respective local EPC networks gather to build the global EPC network, which makes it possible to catch any item with an EPC attached thereto no matter when, where, and which business it has been connected with. The EPC Network proposes the EPC Network Architecture that is architecture capable of collecting unique object information (i.e. EPC) and obtaining related information while removing redundancy of the EPC.

As illustrated in FIG. 1, the conventional EPC Network Architecture may include an RFID reader 102, RFID middleware 104, an EPCIS capturing application 106, a local EPCIS 108, an ONS (Object Naming Service) 110, an EPCIS DS (EPCIS Discovery Service) 112, etc.

Here, when an application system based on the EPC Network Architecture is to be developed, the developer of the application system must observe various interfaces, such as an ALE (Application Level Event) interface and an EPCIS interface, and master communication protocols in order to use various services, such as the RFID middleware 104, the ONS 110, and the EPCIS (EPC Information Service) DS 112. This makes it difficult for the developer to develop the application system.

Further, in developing the application system, if a part in charge of interactions with components of the EPC Network Architecture is mingled with pure business logic having nothing to do with RFID technology, then modifying the business logic causes the complexity of having to also consider technical processing of RFID in connection with the modification of the business logic, which makes it difficult to maintain/support the application system. Additionally, since resources must be invested for processing of RFID technology when the application system is in operation, there is a problem in that inherent tasks to be processed by the application system may be burdened with loads.

Therefore, there is a need to support rapid development and management of an RFID system.

### SUMMARY OF THE INVENTION

Accordingly, the present invention has been made to solve the above-mentioned problems occurring in the prior art, and an object of the present invention is to provide an RFID business-aware framework (RFID BizAF), which can support rapid development and management of an RFID system by providing a base environment including communication technology or a communication module required in developing a real-time RFID application.

Another object of the present invention is to define and manage Business Event Specification (BESpec) for supporting development, operation, and maintenance/repair of a real-time RFID event-based application system so as to provide a middle-level framework capable of promptly coping with the changes between a developer and an RFID system, thereby lowering the cost required in actual business and providing convenience.

In accordance with an aspect of the present invention, there is provided an Radio Frequency Identification (RFID) Business-Aware Framework (BizAF) constructed between an application layer and an RFID middleware layer, including: an event manager module for receiving a subscribe request from an application, recognizing information from a destination, transmitting a currently generated event to a final destination, and for communicating with RFID middleware for generating a business event so as to collect an RFID event in real time; an user interface module for allowing interactions between the RFID BizAF and a user of the RFID BizAF; an eternal accessor module for communicating with an Object Naming Service (ONS) and an EPCIS Discovery Service (EPCIS DS); an EPCIS accessor module for communicating with the EPC Information Service (EPCIS); a Biz event core module for generating an RFID business event or EPCIS event; a BizAF manager module for managing service, reference specifications, and setting information on the RFID BizAF; and a Biz event dispatcher module for transmitting the RFID business event generated by the Biz event core module to an application system, in which the RFID event received via the RFID middleware layer is combined with reference data and business rules by a Business Event Specification (BESpec) so as to define the RFID business event that can be utilized by an RFID application.

In accordance with another aspect of the present invention, there is provided an RFID BizAF constructed between an application layer and an RFID middleware layer, including: an event manager module for receiving a subscribe request from an application, recognizing information from a destination, transmitting a currently generated event to a final destination, and for communicating with RFID middleware for generating a business event so as to collect an RFID event in real time, in which the RFID event received via the RFID middleware layer is combined with reference data and business rules by a BESpec so as to define the RFID business event that can be utilized by an RFID application.

In accordance with another aspect of the present invention, there is provided an RFID BizAF including: a BESpec for defining a process of obtaining information from at least one of RFID middleware, an EPCIS, an ONS, and an EPCIS DS of an architecture component defined in EPCNetwork in developing a real-time RFID event-based application, processing and transmitting the information, wherein the BESpec includes a variable declaration part for storing processing values in the middle of processing an activity, the activity being a basic unit of the work for generating the RFID business event; an activity part for defining the processes that can be combined for generating the RFID business event; and a reference specification part for defining reference information for processing in the activity.

Preferably, the reference specification part includes a ProviderSpec for defining interactions with an event provider providing the real-time event; an EPCIS QuerySpec for defining for storing history information on the RFID in the EPCIS; and an EPCIS CaptureSpec for querying history information or unique information related on the EPC stored in an EPCIS repository.

Preferably, the ProviderSpec includes ECSpec defined in an Application Level Event (ALE) Spec and a keyword in order to use a corresponding ECReport value during processing the BESpec.

Preferably, the keyword is used in any one form of #($reference name).($reportName).($keyword) or #($referenceName).eventTime, wherein String in ($String) means a variable.

Preferably, the activity includes at least one from: a providers activity for referring to the ProviderSpec and collecting a real-time event; an ONS activity for defining interactions with the ONS in order to obtain an address of the EPCIS having unique information; an EPCIS DS activity for interacting with a specific EPCIS DS; an EPCIS activity for referring to the QuerySpec and CaptureSpec so as to perform an EPCIS-related process; a list activity for repeatedly processing; a compute activity for supporting a computing operation for processing; an event activity for defining generating and processing the final RFID business event using the RFID event, RFID event-related reference information, and a computed result; a <condition> element in which a condition expression is described in order to generate the business event; an <action> element including other activity in an inside of the <action> element if a separate process of other activity is required; and a <dataset> element for defining to include related information, such as unique information or history information on a product in generating the business event as a result of a condition being true.

Preferably, the Providers activity includes an <ALE> element for defining on which ProviderSpec is referred for use and an <within> element for defining a case where two or more <ALE> elements exist, the <within> element having a numeral value.

Preferably, the EPCIS activity includes a <getEventData> element used for querying the history information, a <getStaticData> element sued for querying the unique information, and a <captureEventData> element for storing the history information in the EPCIS.

In accordance with another aspect of the present invention, there is provided an RFID BizAF including: an event manager module including a transmitting module and receiving module and for requesting and receiving an asynchronous event; an user interface module for interacting between the RFID BizAF and a user of the RFID BizAF; an external accessor module for communicating with an ONS and EPCIS DS; an EPCIS accessor module for communicating with the EPCIS; a Biz event core module for interpreting each specification, performing a corresponding work using functions of other modules, and finally generating the RFID business event or EPCIS event; a BizAF manager module for managing a service, reference specifications, setting information on the RFID BizAF and initializing and managing another module within the BizAF; and a Biz event dispatcher module for transmitting the RFID business event generated by the Biz event core module to an application system.

Preferably, the user interface module includes: an UserInterfaceManager for managing general flow; a ConfigurationManager for managing information on a reference system; a ProviderSpecManager, CaptureSpecManager, and QuerySpecMAnager for obtaining a reference specification from a ProviderSpec, an EPCIS QuerySpec, and an EPCIS CaptureSpec, respectively; and a BusinessEventManager for obtaining a BESpec and performing start and stop of a service generating the business event.

Preferably, the Biz event core module includes a Captureprocess for referring to information on the ProviderSpec and transmitting the ECSpec to RFID middleware using the EventManager module and a BizProcess including a class corresponding to a variable and an activity defined in the BESpec.

Preferably, if the CaptureProcess receives an RFID event through the event manager module, the CaptureProcess refers to information on the EPCIS QuerySpec, converts the RFID event into an EPCIS event, and stores the converted EPCIS event in the EPCIS by using the EPCIS accessor module.

### BRIEF DESCRIPTION OF THE DRAWINGS

FIG. 1 is a diagram illustrating the conventional EPC Network Architecture.

FIG. 2 is a diagram illustrating the BESpec according to an exemplary embodiment of the present invention.

FIGS. 3A to 3Z are the XML schema specification of a schema of the BESpec according to an exemplary embodiment of the present invention.

FIG. 4 is a diagram illustrating activities in the BESpec according to an exemplary embodiment of the present invention.

FIG. 5 is a diagram illustrating an event period for a plurality of real-time data in the BESpec according to an exemplary embodiment of the present invention.

FIG. 6 is a diagram illustrating an entire construction of a BizAF according to an exemplary embodiment of the present invention.

FIG. 7A to 7G are diagrams illustrating an internal module of a BizAF according to an exemplary embodiment of the present invention.

FIG. 8 is a physical arrangement diagram illustrating a business-aware framework according to an exemplary embodiment of the present invention.

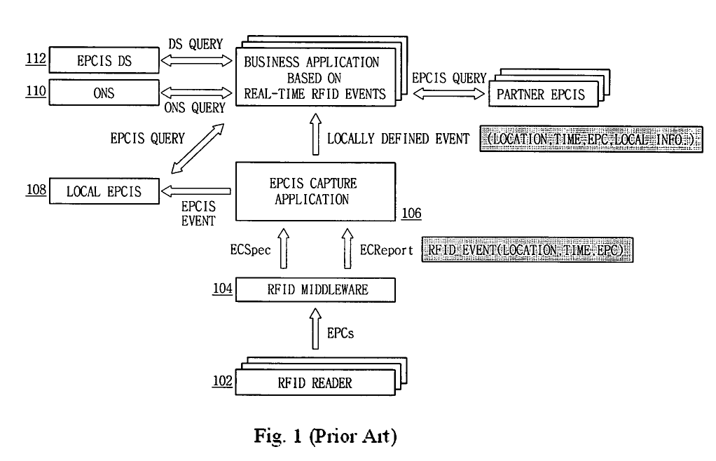

### DETAILED DESCRIPTION OF THE PREFERRED EMBODIMENTS

Hereinafter, an advantage, characteristic, and method for achieving them will become apparent from the reference of the following exemplary embodiments, in conjunction with the accompanying drawings. However, the present invention is not limited to the embodiments but may be implemented into different types of forms. These embodiments are provided only for illustrative purposes and for full understanding of the scope of the present invention by those skilled in the art. Throughout the drawings, like elements are designated by like reference numerals.

The present invention includes a Business Event Specification (BESpec) for defining a process of obtaining and processing an event for supporting the development of a real-time RFID event-based application and an (RFID) Business-Aware Framework (BizAF) for practically applying the BESpec.

The BESpec is described by a user of the BizAF and defines how and in what sequence the BizAF communicates with a plurality of components of an EPC Network Architecture, obtains information, applies business rules to the information, and generates a business event. Preferably, the BESpec can be defined in XML schema for convenient description and expansibility, but is not limited thereto.

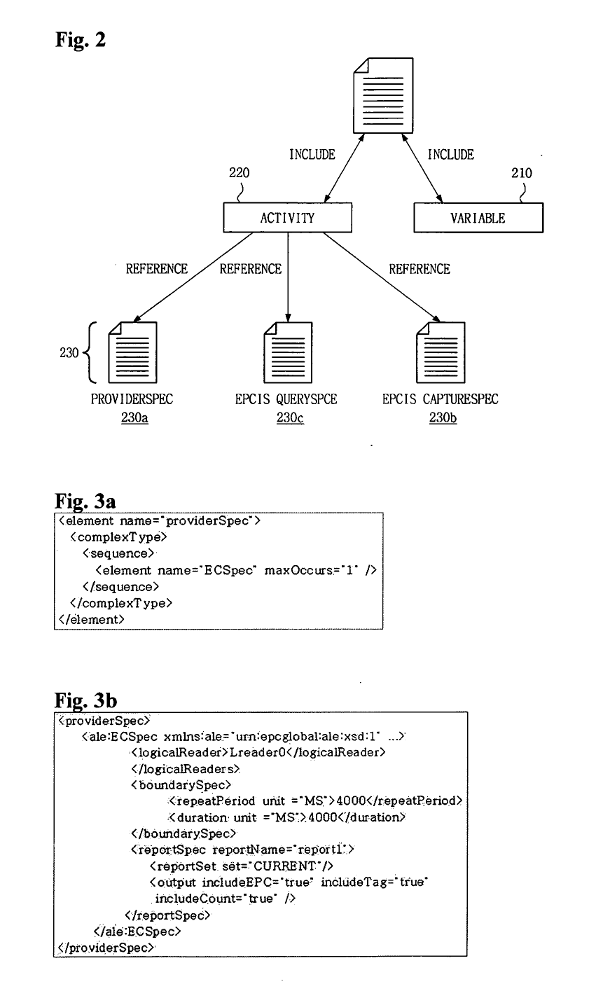

FIG. 2 is a diagram illustrating the BESpec according to an exemplary embodiment of the present invention. As illustrated in FIG. 2, the BESpec generally includes three parts, i.e. a variable declaration part 210, an activity part 220 for defining various processes, and a reference specification part 230 referred for processing in the activity.

The variable declaration part 210 is used for storing processing values in the middle of processing the activity. A result processed in one activity through the variable can be used in another activity. The activity having various roles that can be combined for generating an RFID business event is defined in the activity part 220, so that the respective activity parts 220 can have a different attribute value to be internally described. The reference specification 230 includes a Provider Specification (ProviderSpec) 230a for processing interaction with RFID middleware, an EPCIS Query Specification (QuerySpec) 230c for processing interaction with, the EPCIS, and an EPCIS capture Specification (CaptureSpec) 230b. The respective reference specifications are defined to observe a standard interface of the EPC Network Architecture and are independent of the BESpec so that, even if an interface of a specific component of the EPC Network Architecture is modified later on, the process can be implemented with modifying only specific reference specification, without modifying the BESpec itself.

The reference specification, the variable, the activity, and the BESpec including the entire contents will be described in sequence in more detail.

The reference specification 230 may include the ProviderSpec 230a, EPCIS QuerySpec 230c, and EPCIS CaptureSpec 230b.

The ProviderSpec 230a is a specification defining the interactions with an event provider providing a real-time event. Here, the specification can be constructed with defining the real-time event provider as the RFID middleware or constructed to be expandable in the definition with respect to collecting the real-time event from Real-Time Locating Systems (RTLS) or a plurality of sensors. The EPCglobal defines the Application Level Event (ALE) interface of the RFID middleware under ALE Spec 1.1. According to ALE Spec, if the ECSpec is defined in the RFID middleware, the EPC information collected from an RFID reader is transmitted in the form of an ECReport. Then, the ProviderSpec 230a includes the ECSpec defined in the ALE Spec and a keyword for using a value of the ECReport during the process of the BESpec. The ProviderSpec 230a described by the user of the BizAF can be registered in the BizAF and a name capable of being referred on registering is registered together with the ProviderSpec 230a so as to use the ProviderSpec 230a in the BESpec through the reference name.

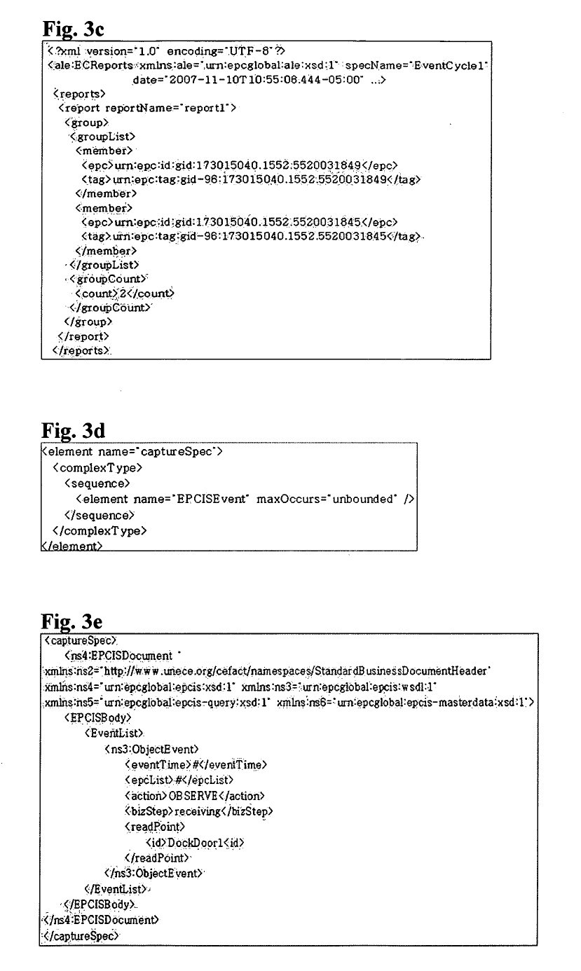

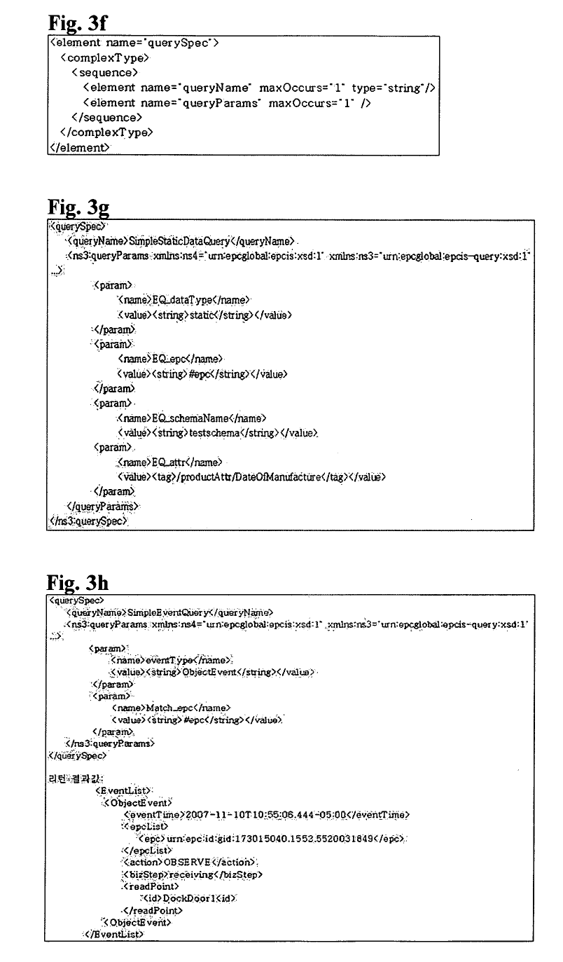

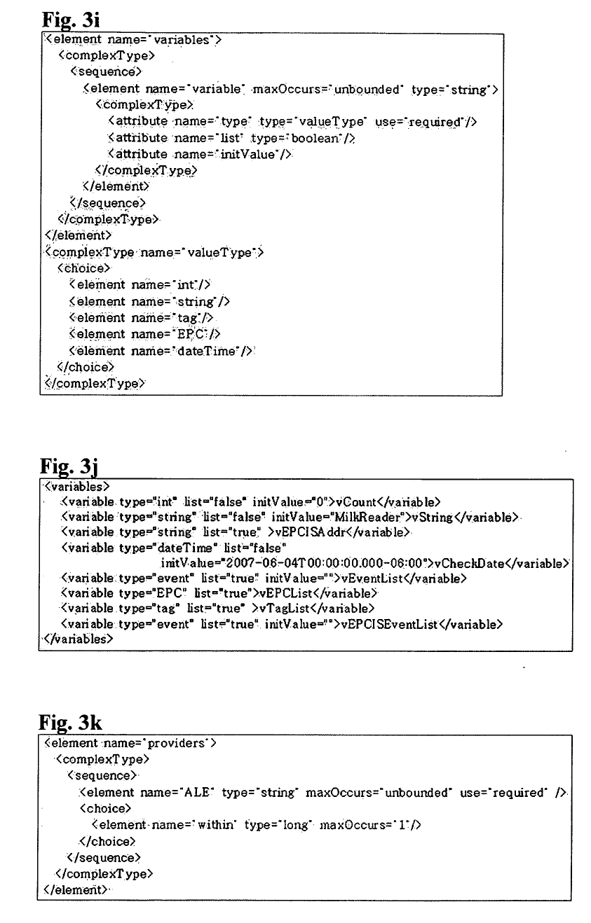

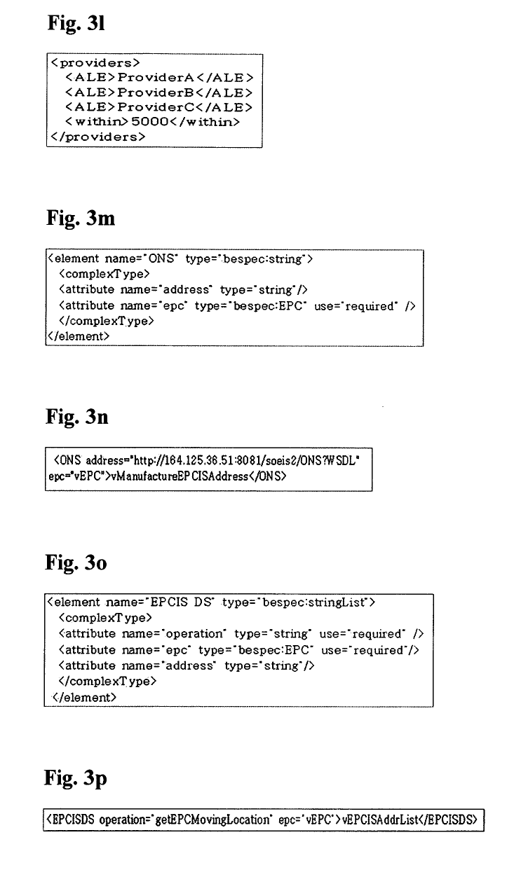

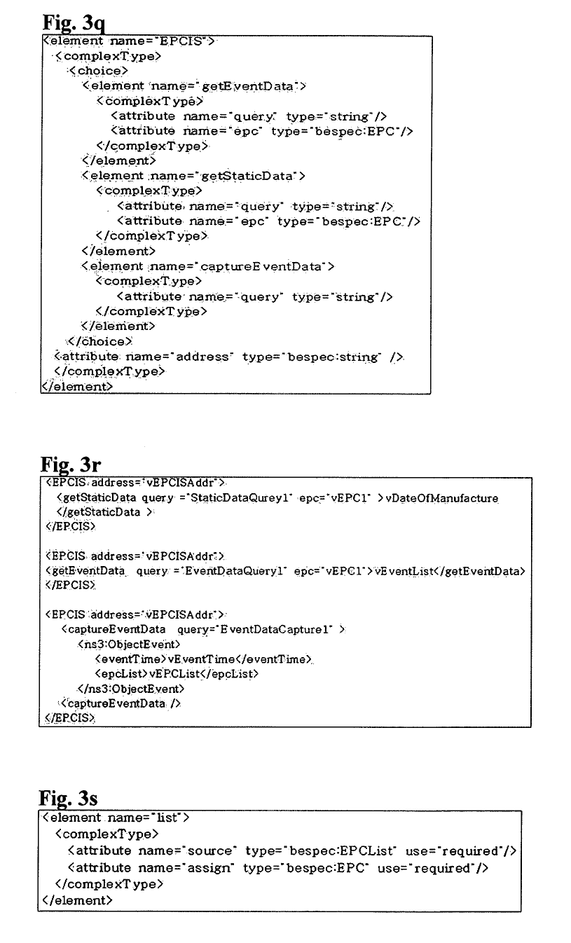

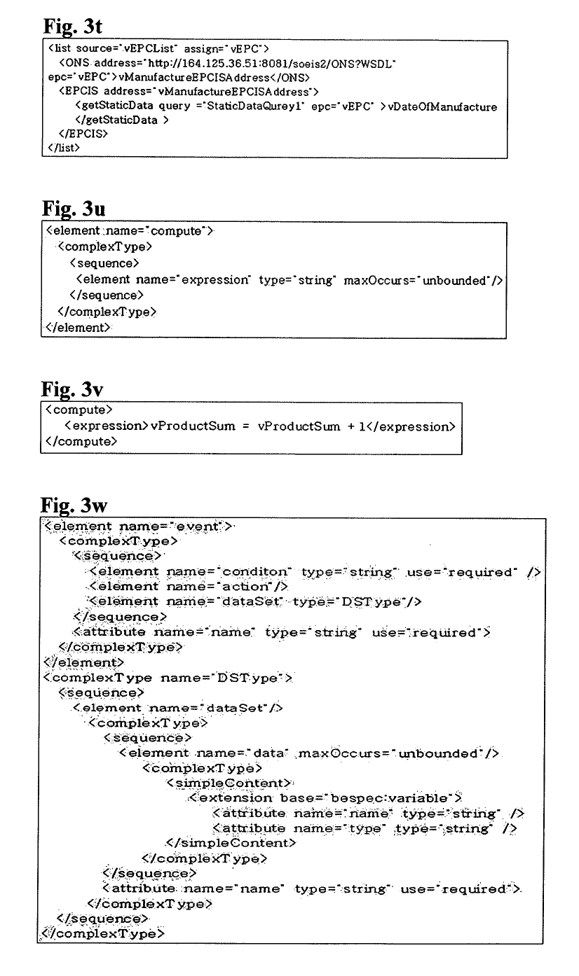

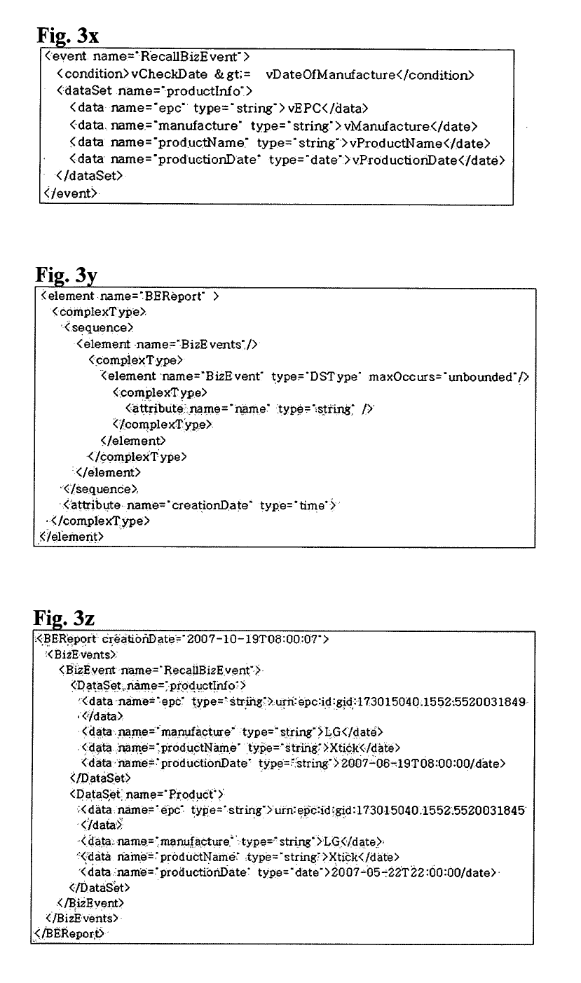

FIG. 3A illustrates a schema of the ProviderSpec 230a. As illustrated in FIG. 3A, the schema of the ProviderSpec 230a can include an element of a single ECSpec and the detailed schema of the ProviderSpec 230a refers to the ALE Spec 1.1.

FIG. 3B illustrates an example of the ProviderSpec 230a. As illustrated in FIG. 3B, the BizAF receives the EPC information collected on Lreader0 of a logical RFID reader connected to the RFID middleware.

For example, the BizAF receives the ECReport including information in which the redundant EPC is removed every 4 seconds. Preferably, the ProviderSpec 230a can provide keywords represented in Table 1 for referring to the ECReport received from the RFID middleware.

TABLE 1

| Keyword | Explanation |
|---|---|
| epcList | Refer to list of EPC value |
| tagList | Refer to list of tag value |
| count | Refer to the number of EPCs |
| eventTime | Refer to generation time of ECReport |

FIG. 3C illustrates an example of the ECReport received from the RFID middleware by the BizAF when the ProviderSpec 230a is defined in the RFID middleware.

Referring to FIG. 3C, it can be identified that two tags are read by the RFID reader and the BizAF receives the EPC information included in the tag. Here, attribute information included in the ECReport can be referred using the keyword. The formation of using the keyword is as follows. String in ($String) refers to a variable.

#($referenceName).($reportName).($keyword)

#($referenceName).eventTime

If the ProviderSpec 230a like FIG. 3B is registered with the reference name of provider1 in the BizAF, the ProviderSpec 230a is referred with the description of #provider1.report1.epcList, and a value obtained through such a reference can be a list of the EPC shown in below.

urn:epc:id:gid:173015040.1552.5520031849

urn:epc:id:gid:173015040.1552.5520031845

Next, the CaptureSpec 230b is a specification for defining to store history information on the RFID in the EPCIS. The CaptureSpec 230b refers to an EPCIS Event in CaptureService defined in EPCIS Spec 1.0. The EPCIS event includes the subclasses of an Object Event, Aggregation Event, Quantity Event, and Transaction Event and the respective events have several attributes.

FIG. 3D illustrates a schema of the CaptureSpec 230b. As illustrated in FIG. 3D, the schema of the CaptureSpec 230b includes an EPCIS Event 342. The BizAF generates the EPCIS event according to the defined EPCIS event and stores the generated EPCIS event in the EPCIS. The BESpec uses contents of the ECReport received in real-time through the reference of the ProviderSpec 230a as an input value and stores the EPCIS event in the EPCIS with referring the CaptureSpec 230b. In this case, the attribute information included in the RFID event transmitted in real time cannot be identified in advance at the time of defining the CaptureSpec 230b so as to preferably use a #keyword.

FIG. 3E illustrates an example of the CaptureSpec 230b. Referring to FIG. 3E, it can be identified that one object event is defined and a value is statically defined in an <action> element, a <bizStep> element, and a <readpoint> element. The #keyword is used in an <eventTime> element and <epcList> element, respectively, in which a value is dynamically allocated by using a name of the element having the designated #keyword during the interpretation of the BESpec, so as to generate the EPCIS event.

Next, the QuerySpec 230c is a specification for querying history information or unique information related on the EPC stored in an EPCIS repository and is referred in the BESpec.

In order to query the information related on the EPC using the EPCIS, an EPCIS Query Control interface under the EPCIS Spec 1.0 must be observed. Poll( ) in the EPCIS Query Control interface is an operation capable of querying the information stored in the EPCIS in an asynchronous manner and the QuerySpec 230c is defined to obtain the history information and unique information using poll( ).

FIG. 3F illustrates a schema of the QuerySpec 230c. The schema of the QuerySpec 230c includes queryName and queryParams. The queryName defines what kinds of queries are queried and a query condition is inputted in the queryParams. The schema of the queryName and queryParams refers to the EPCIS spec. It has not been determined that the information related on a product of what EPC is supposed to be queried at the time of defining the QuerySpec 230c, so that an epc value can be dynamically defined with the keyword of #epc.

FIG. 3G illustrates an example of querying information on a manufacturing date of a product including the EPC.

SimpleStaticQuery having a meaning of querying unique information is described in the queryName and three conditions are set in the params. A character string of EQ_epc in the conditions means to find the EPC corresponding to a specific EPC, in which the keyword of #epc is described and it is defined that the value of the EPC is dynamically set later on to be queried to the EPCIS. If the query is made to the EPCIS under the assumption that an arbitrary EPC value is set, the information on the manufacturing date, like 2007-07-05T16:51:24.000+09:00, can be obtained.

FIG. 3H illustrates an example of querying history information on a product including the EPC.

The QueryName of SimpleEventQuery 382 means to query the history information and the condition of an object event 384 and the keyword of #epc are used as the params. If the query is made to the EPCIS under the assumption that the specific EPC value is set as urn:epc:id:gid:173015040.1552.5520031849, the related Object event returns as a result.

In the meantime, the BESpec includes several processing steps, i.e. the activity, and uses a variable as medium for transmitting and receiving the processed result between the respective activities. A variable type supported in the BESpec includes a basic type of int and string, an RFID specialized type of EPC, tag, and event, and a time expression type of dateTime. The EPC and tag types are defined to store and refer to the EPC value of a tag and the event type is defined to store and refer to one EPCIS event. The dateTime type is identical to dateTime of xml schema. Further, every variable type is designed for expressing and referring to the list of the specific type through the list attribute.

FIG. 31 illustrates a schema of the variable. As illustrated in 31, the variable is expressed in an element of <variables>. It is possible to designate the variable type in type, set whether or not to be the list type, and designate an initial value is designated in initValue. Once the list has been set, it is not capable of designating the initial value. The variable in the BESpec is designated as a name space of bespec and the variable of the list type is expressed as variableName+List for discriminating the general data type expressed in the schema.

FIG. 3J is an example of the respective variable types. The activity is a basic unit of the operation for generating the RFID business events and is defined in the BESpec. Generating the RFID business events requires the interaction between the RFID middleware, ONS, EPCIS DS, and EPCIS and various processes for processing the information received from each component. The respective operations are defined as the independent activities and each activity can define other business event according to how the activity is combined within the BESpec.

TABLE 2

| Activity Name | Explanation |
|---|---|
| Providers | Collect a real-time event from a real-time event provider |
| ONS | Query an address of the EPCIS including unique |
| | information from ONS |
| EPCIS DS | Query an address of the EPCIS DS including history |
| | information from the EPCIS DS |
| EPCIS | Query attribute information and history information |
| | from EPCIS |
| List | Repeatedly process a list type of a variable |
| Compute | Process an computing operation |
| Event | Apply a rule and generate a business event |

The kinds of activities defined in the BESpec are as Table 2. Each respective activity processes its inherent work and has attribute for internally processing the work. The activity can include another activity therein due to the nature of the operation.

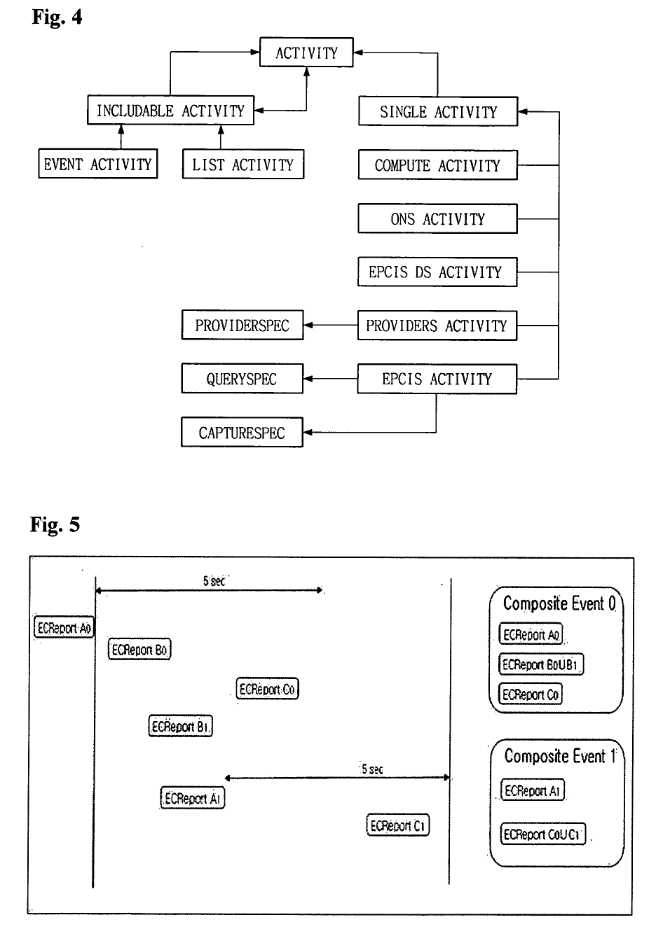

Here, as illustrated in FIG. 4, the activity can be classified into an includable activity and a single activity. Further, the afore-mentioned reference specification is used for processing the operation in the specific activity.

In the meantime, the Providers activity refers to the ProviderSpec 230a so as to collects the real-time events. Here, the real-time event provider is limited to the RFID middleware, so that it is regulated to observe the ALE interface, transmit the ECSpec, and receive the ECReport.

As illustrated in FIG. 3K, a structure of the Providers activity includes an <ALE> element and a <within> element.

The <ALE> element defines which ProviderSpec 230a is referred for use. Therefore, a value of the <ALE> element must be described with the reference name of the ProviderSpec 230a. Further, if several ProviderSpecs 230a are defined, a plurality of <ALE> elements is repeatedly described so as to refer to the values of several ECReports.

Further, the <within> element can have a numeral value of millisecond, wherein when the Provider activity includes two or more <ALE> elements, the definition is available.

The meaning of the numeral value described in the <within> element is ‘t’ of the following equation.

Where CE=Composite Event, RE=RFID Event,

CE=Within(RE0, RE1, . . . , REn, t)

That is, RE is collected per described ProviderSpec 230a, and CE is a set of every REs generated within a time of t from a point of time at which the RE related on the first defined ProviderSpec 230a.

In the meantime, if the number of <ALE> element is one, the <within> element is of course not described, but even if the number of <ALE> element is two, the <within> element may not be described. The meaning of the several <ALE> elements having no <within> element is to aggregate the RE while waiting until every related BEReport is collected with reference to the first collected BEReport among the BEReport corresponding to the ProviderSpec 230a referred in every <ALE> element.

FIG. 3L is an example of the Providers activity. Assuming that three different ProviderSpecs 230a are described and have the reference names of ProviderA, ProviderB, and ProviderC, respectively, a value of the <within> element is defined as 5000. At this time, as illustrated in FIG. 3L, the processing of the described Providers activity can be understood with reference to an example illustrated in FIG. 5.

If it is assumed that the ECReports received through the definition of the respective ProviderSpecs 230a are represented as ECRreportA, ECRreportB, and ECRreportC, the RFID middleware periodically transmits each respective ECReport to the BizAF. At this time, the ECReport received within 5000 milisecond from a point of time of receiving ECReportA0 is aggregated and is aggregated again from a point of time of receiving ECReportA1.

Such a processing of the Providers activity comes to have a higher-level concept when a plurality of RFID events defined with the different types is combined so as to generate the RFID business event. Further, if the ProviderSpec is expanded for collecting the RTLS and sensor event, as well as the RFID event, the processing of the Providers activity can combine the event having the different types for use.

Further, the unique information on the EPC-related product can be generally queried through the EPCIS of a manufacturing company, and an ONS activity defines the interaction with the ONS for obtaining an address of the EPCIS having the unique information on the product.

FIG. 3M illustrates a structure of the ONS activity. As illustrated in FIG. 3M, an address attribute is address information on the ONS, and in an epc attribute must be set the variable having a value of the EPC to be transmitted to the ONS for querying.

FIG. 3N is an example of the ONS activity. As illustrated in FIG. 3N, the activity is set assuming that the address of the ONS is described and the EPC information to be queried is stored in an EPC-type variable of vEPC. At this time, the address of the EPCIS obtained resulted from the query to the corresponding ONS is stored in a string-type variable of vManufactureEPCISAddress.

At this time, the ONS activity can be omitted, and this case is processed to query to the ONS originally set in the BizAF. The history information on a specific EPC-related product is dispersively stored in the EPCIS globally distributed according to logistics so that it is difficult to accurately find where the history information is stored. Due to such a problem, an EPCIS DS for searching for the list of the EPCIS address storing the history information on the product must be used for retrieving the history information. An EPCIS DS activity is in charge of interaction with a specific EPCIS DS.

FIG. 3O illustrates a structure of the EPCIS DS activity. As illustrated in FIG. 3O, in an operation attribute is defined a support operation of the EPCIS DS and in an epc attribute is defined the EPC variable to be queried. The operation attribute supports getEPCMovingLocation returning the address list of the EPCIS providing the history information on the EPC. The address of the EPCIS DS to be interacted can be described in the address attribute, but if the address is not described, the address of the basic EPCIS DS set in the BizAF is used in the address attribute.

FIG. 3P is an example of the EPCIS DS activity. The address list of the EPCIS storing the history information on the EPC value stored in the vEPC variable is stored in a vEPCISAddrList variable. The EPCIS DS activity processes the interaction with the EPCIS and defines the process of the query of the unique information or history information on the product or storing the history information in the EPCIS. The EPCIS activity refers to the QuerySpec 230c and CaptureSpec 230b so as to execute the process related to the EPCIS.

FIG. 3Q illustrates a structure of the EPCIS activity. As illustrated in FIG. 3Q, the EPCIS activity includes the address attribute in which the address of the EPCIS to be interacted is set and <getEventData>, <getStaticData>, or <captureEventData> is selected according to the processing purpose of the activity for use. The <getEventData> element is used for querying the history information and the reference name of a specific QuerySpec 230c is described in a query attribute to be referred for processing the EPCIS query. A name of EPC variable is defined in an epc attribute to set the EPC value to be queried on #epc location of a keyword of the QuerySpec 230c. The <getStaticData> element is used for querying the unique information and the part related on the reference of the QuerySpec 230c and the epc attribute is identical to the <getEventData> element. The <captureEventData> element is a part for storing the history information in the EPCIS and refers to the CaptureSpec 230b to capture it in the EPCIS. For allocating the value on the keyword defined in the CaptureSpec 230b, the structure of a specific element of the CaptureSpec 230b including the defined keyword is described in an internal of the <captureEventData> element to transmit it.

FIG. 3R is an example of the EPCIS activity. As illustrated in FIG. 3R, the first EPCIS activity is described to query the unique information. It can be noted that the first EPCIS activity is defined to refer the QUerySpec 230c having the reference name of StatisDataQuery1 and store the query result on vDateOfManufacture of a dataTime-type variable. The second EPCIS activity is described to query the history information. It can be noted that the second EPCIS is defined to refer the QuerySpec 230c having the reference name of EventDataQuery and store the query result in vEventList of a list-type event variable. The third EPCIS activity is described to store the history information. It can be noted that the third activity is defined to refer EventDataCapture1 of the CaptureSpec 230b, in which the third EPCIS activity can dynamically allocate time information and EPC information through the keyword defined in the referred CaptureSpec 230b. The ECReport collected from the RFID middleware includes the list of the EPC. Therefore, the repeated processing of the same operation is required for the several EPCs, in which a List activity is in charge of such a repeated processing.

As illustrated in FIG. 3S, the list activity is defined to use a <list> element. The <list> element includes two attributes of a source attribute and an assign attribute. The source attribute describes a list of an object to execute the repetitive processing in which a list-type EPC variable can be defined. The List element can include other activities therein and the operation of the included activity is repeatedly performed as much as size of the list variable expressed in the source. In the assign attribute is allocated a specific value of the list defined in the source so as to describe a variable name to be used in the activity included in the internal of the list element.

FIG. 3T is an example of the list activity. As illustrated in FIG. 3T, in the source attribute is set a vEPCList variable having the value of the list of the EPC and in the assign attribute is set a variable for storing a single EPC value of vEPC. The processing of the ONS and EPCIS activities is included in the list element are repeated as many as the number of EPCs stored in the vEPCList. Here, it requires a basic arithmetic process, such as calculating the sum of the specific numbers or calculating the number of EPCs satisfying a specific business rule in generating the RFID business event. A Compute activity supports a basic arithmetic operation for supporting such a processing work.

FIG. 3U illustrates a structure of the Compute activity. As illustrated in FIG. 3U, an arithmetic operation expression can be defined by using a variable in an <expression> element and a support operator is as Table 3. Then, FIG. 3V illustrates an example of an int-type vProductSum variable.

TABLE 3

| Type | Operator |
|---|---|
| Arithmetic operator | +, −, *, / |
| Allocation operator | = |
| Precedence operator | (, ) |

An event activity defines a process of finally generating the RFID business event by using the RFID event and several reference information related on the RFID event and calculation result.

As illustrated in FIG. 3W, the event activity includes a name attribute for discriminating the event, a <condition> element, an <action> element, and a <dataset> element.

The <condition> element is described with a conditional equation for generating the business event. If the conditional equation is true, the business event is generated, and if the conditional equation is false, the business event is not generated. The operator supporting the conditional equation is as Table 4.

TABLE 4

| Type | Operator |
|---|---|
| Relational operator | ==, !=, >, <, >=, <= |
| Logical operator | &, \| |
| Precedence operator | (, ) |

The <action> element can include other activity therein in which the activity included in a case of the conditional equation in the <condition> element being true is executed. However, if a separate processing of other activity is not required, the <action> element can be omitted.

The <dataset> element is defined to include relational information, such as unique information or history information on the product, when the condition is true so as to generate the business event. The <dataset> element can include a set of <data> elements representing unique independent information.

FIG. 3X illustrates a use example of the event activity defined for recalling the product manufactured prior to a specific date. If the variable of a defined specific date is compared with the variable defined to store the manufacturing date of the product and the result of the condition is true in the <condition> element, it is defined as the business event having a name of RecallBizEvent is generated and product information is defined as correspondingly related information.

The meaningfully named business event is defined as an XML message in the form of a Business Event Report (BEReport). The BEReport is generated by the BizAF and transmitted to a receipt address of an application system.

FIG. 3Y illustrates a schema of the BEReport. A plurality of event activities can be defined in a single BESpec, in which the event generated by the respective activities corresponds to a <BizEvent> element of the BEReport. A <dataSet> element in the <BizEvent> is defined identically to the construction of the <dataSet> element defined in the <Event> activity.

FIG. 3Z illustrates an example of the BEReport corresponding to the example of the event activity described in FIG. 3X.

As such, the BESpec is defined and the defined BESpec obtains, processes, and transmits the actual information through the BizAF.

Hereinafter, the construction and implementation of the BizAF will be described.

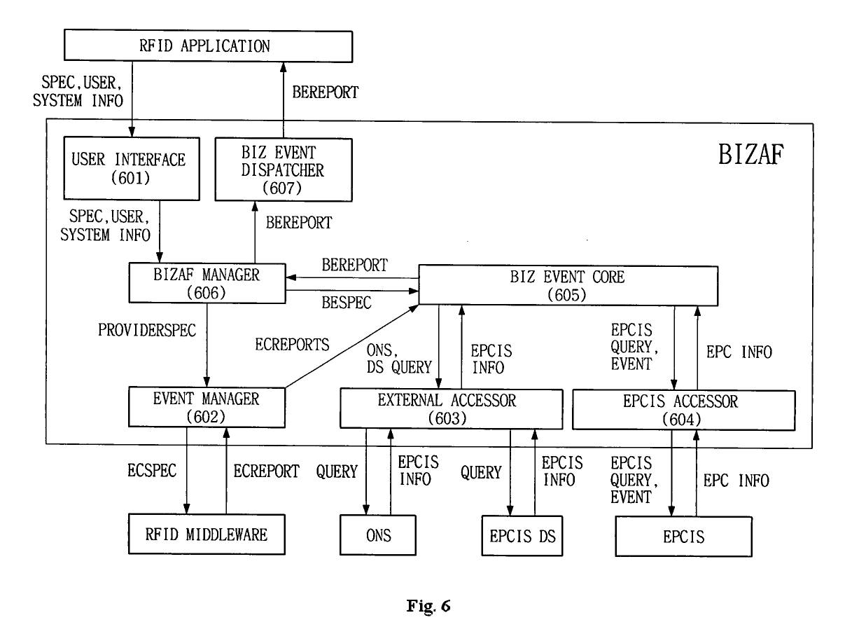

In order for the BizAF to provide the business event service, it requires a module capable of actually interpreting the BEspec and communicating with the RFID middleware 104, the EPCIS DS 112, the ONS 110, and the EPCIS. Further, the user interface allowing the user of the BizAF to define the RFID business event is required. According to such needs, the internal constructional modules of the BizAF of FIG. 6 are analyzed.

The internal module of the BizAF includes an user interface 601, an event manager 602, an external accessor 603, an EPCIS accessor 604, a Biz event core 605, a BizAF manager 606, and a Biz event dispatcher 607. The respective modules are in whole charge of interacting with the external component or internally managing the module and processing the information, respectively.

The user interface 601 module allows the interactions between the BizAF and the user of the BizAF.

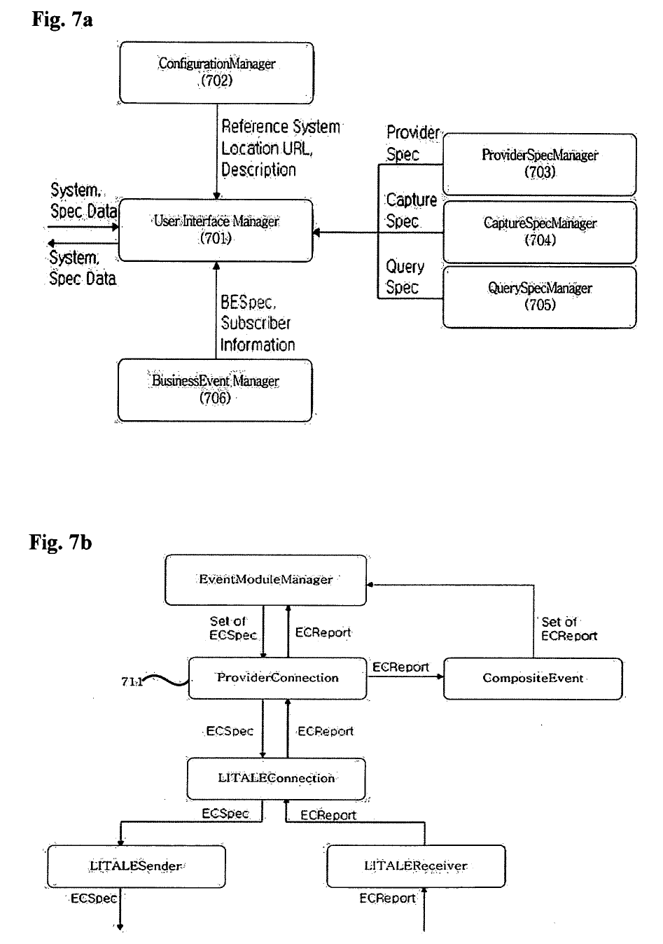

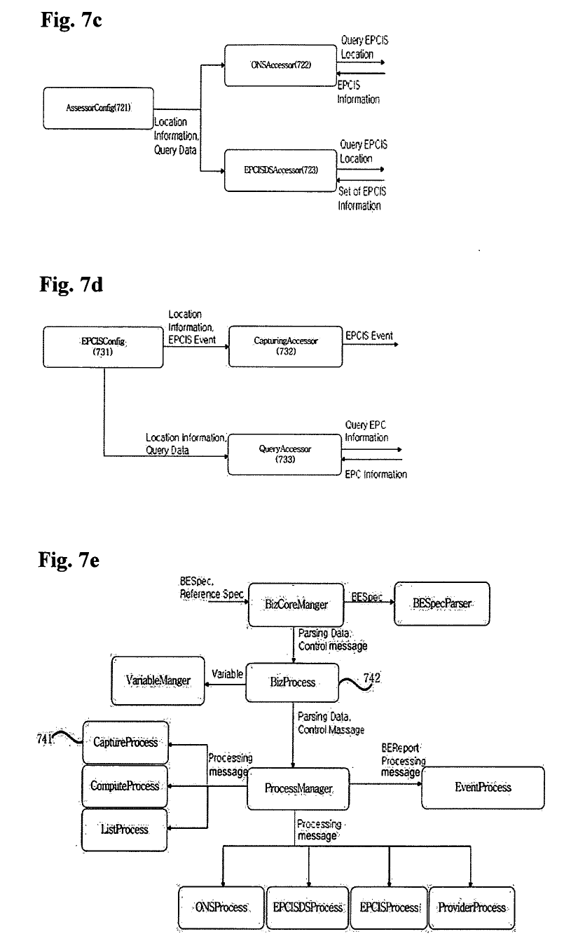

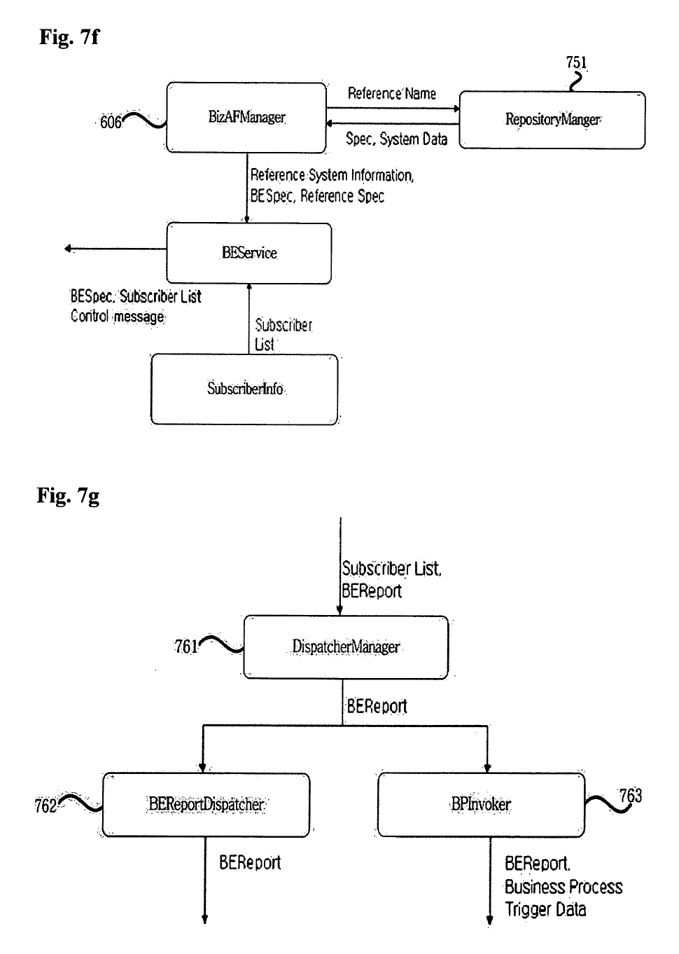

FIG. 7A is a diagram illustrating the user interface 601. An UserInterfaceManager 701 internally manages general flow and information on the reference system through ConfigurationManager 702. The UserInterfaceManager 701 obtains each reference specification through ProviderSpecManager 703, CaptureSpecManager 704, QuerySpecManager 705 and the BESpec through a BusinessEventManager 706 and performs the start and stop of the service generating the business event. The user of the BizAF can generate or delete the event service and manages the reference specification through the user interface.

The BizAF must collect the RFID event in real time through communicating with the RFID middleware for generating the business event. Further, the BizAF must collect the state of the RFID middleware, the state of the RFID reader, or the construction information for monitoring. To this end, the RFID BizAF constructed between an application layer and an RFID middleware layer includes the event manager 602 module recognizing information from a destination after receiving a subscribe request from the application and transmitting a currently generated event to a final destination, and communicating with the RFID middleware and collecting the RFID event in real time for generating the business event. Further, the RFID BiZAF combines the RFID event received through the RFI middleware layer with the reference data and a business rule by the BESpec so as to define the real-time RFID business event that can be utilized in the RFID application.

As illustrated in FIG. 7B, the event manager 602 module is designed to include a transmitting module and receiving module for requesting and receiving the asynchronous event. Further, the event manager 602 is designed to enable to inherit and further include a specific module of a ProviderConnection 711, even if it expands later for communicating with various event providers, such as the sensor and RTSL, as well as the RFID middleware.

As illustrated in FIG. 7C, the external accessor 603 module is in charge of communicating with the ONS and EPCIS DS. An AssessorConfig 721 manages the address of the ONS and EPCIS DS and the actual communication is processed in an ONSAccessor 722 and EPCISDSAccessor 723.

The EPCIS accessor 604 module shown in FIG. 7D is in charge of communicating with the EPCIS. An EPCISConfig 731 manages information on the physical location of the reference EPCIS, and if a capture interface among the EPCIS interface is used for adding new data, a CapturingAccessor 732 transmits the data. In the meantime, in retrieving the history information and product information, the query is processed to the EPCIS through a QueryAccessor 733.

The Biz event core 605 module is the most core module in a plurality of modules within the BizAF that is interprets each specification, performs the corresponding work using the functions of other several modules, and finally generates the RFID business event or EPCIS event.

FIG. 7E illustrates a structure of the Biz event core 605 module. As shown in FIG. 7E, a CaptureProcess 741 and BizProcess 742 module of the Biz event core 605 module corresponds to RFID business event service and EPCIS capturing service, respectively.

The CaptureProcess 741 refers to information on the ProviderSpec 230a and transmits the ECSpec to the RFID middleware using the EventManager 602 module. Then, if the CaptureProcess 741 receives the RFID event through the event manager 602, the CaptureProcess 741 refers to the information on the CaptureSPec 230b, converts the RFID event into the EPCIS event, and stores the converted EPCIS event in the EPCIS using the EPCIS accessor 604 module.

The BizProcess 742 includes a class corresponding to the variable and activity defined in the BESpec. Each activity of the BESpec is represented as the independent process classes and the respective processes perform the work using other external module of the Biz event core 605. The ProcessSpec includes the list of the processes of the ProcessSpec in sequence and the BizProcess 742 performs the list of the process in sequence. Such a structure is constructed not to influence to the total structure, even if the definition of the specific activity of the BESpec is modified or a new activity is added later on.

The BizAF manager 606 module is a main module of the BizAF, and manages every service, reference specification, and setting information on the BizAF, and initializes and manages another module in the BizAF.

FIG. 7F illustrates a relation of a detailed operation related on the BizAF manager 606.

A BizAF server is operated as an RMI server and the BizAF manager 606 of a particular module manages the RFID business event service, reference specifications, and user's information. The user interface 601 module processes the screen using the interface of the BizAF manager 606 module. The event service generated or reference specification registered in the BizAF by the user are managed in the form of the file through a RepositoryManager 751 for permanently maintaining the information, even though the BizAF server is interrupted and executed again.

As illustrated in FIG. 7G, the Biz event dispatcher 607 module transmits the RFID business event generated by the Biz event core 605 module to the application system. The event can be transmitted through the interface of the DispatcherManager 761 in the Biz event core 605 module. The business event can be transmitted to the application system in two ways, and one is to transmit the BEReport using a TCP socket and the other is to call a business process arranged in a BPEL engine. The respective ways are provided through a BEReportDispatcher 762 and BPInvoker 763.

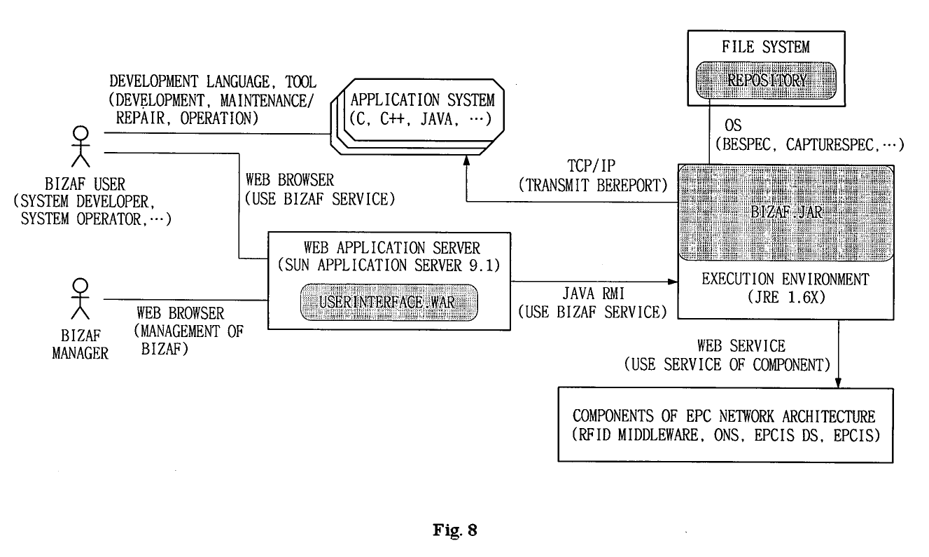

The internal modules of the BizAF are constructed as described above, and FIG. 8 illustrates an actual physical arrangement of the internal modules of the BizAF.

As illustrated in FIG. 8, the BizAF manager manages information on the system construction of the EPC network and manages the related reference specification. The user of the BizAF can generate a new business event through combining the registered information on a web environment by the manager and the generated business event is received in the form of the BEReport.

Such a RFID BizAF of the present invention has the following advantages.

First, conventionally, the developer must acquire the interface and protocols for the several components of the EPC Network for developing the RFID application system only with the EPC Network Architecture suggested by the EPCglobal and the RFID solution suggested by and global vendors and develop the communication module so that it is not efficient in time and cost aspects required for the development. Further, in the application system developed with such a method, a part in charge of communicating with components of the EPC Network Architecture is mingled with business logic so as to increase complexity and make it difficult to maintain/support the application system. Furthermore, the application system cannot concentrate on its inherent work. However, the BESpec capable of defining the RFID business service and business event of the BizAF according to the present invention is used so as to solve the conventional problems, and using the BizAF reduces the time required for developing and the development modules in comparison of using no BizAF so as to efficiently develop the RFID business application system.

Second, the information is processed according to the real-time RFID event, in contrary to the conventional application system of developing using only the EPCIS so that this can be usefully used in monitoring required to be performed in real time at the moment the RFID tag is recognized and the operation control-related application.

Although the present invention have been described for illustrative purposes, those skilled in the art will appreciate that various modifications, additions and substitutions are possible, without departing from the scope and spirit of the invention as disclosed in the accompanying claims.

What is claimed is:

1. An Radio Frequency Identification (RFID) Business-Aware Framework (BizAF) constructed between an application layer and an RFID middleware layer, comprising:
an event manager module for receiving a subscribe request from an application, recognizing information from a destination, transmitting a currently generated event to a final destination, and for communicating with RFID middleware for generating a business event so as to collect an RFID event in real time,
an user interface module for allowing interactions between the RFID BizAF and a user of the RFID BizAF,
an eternal accessor module for communicating with an Object Naming Service (ONS) and an EPCIS Discovery Service (EPCIS DS),
an EPCIS accessor module for communicating with the EPC Information Service (EPCIS),
a Biz event core module for generating an RFID business event or EPCIS event,
a BizAF manager module for managing service, reference specifications, and setting information on the RFID BizAF, and
a Biz event dispatcher module for transmitting the RFID business event generated by the Biz event core module to an application system,
in which the RFID event received via the RFID middleware layer is combined with reference data and business rules by a Business Event Specification (BESpec) so as to define the RFID business event that can be utilized by an RFID application.

2. The RFID BizAF as claimed in claim 1, wherein the user interface module enables the user to register information on the reference specification and a reference system and manages generating a new event service through combining the reference specification, modifying, deleting, and monitoring the event, monitor of the event, and authorizing the user.

3. The RFID BizAF as claimed in claim 1, wherein the event manager module comprises a transmitting module and receiving module requesting and receiving an asynchronous event in order to collect the RFID event in real time while communicating with the RFID middleware and collect an RFID middleware state, RFID reader state, or construction information for monitoring service, the event manager module being expansible for collecting RTLS and sensor data.

4. The RFID BizAF as claimed in claim 1, wherein the Biz event core module interprets the reference specification related on the BESpec in which the event supposed to generate the RFID business event of the RFID BizAF is defined, operates corresponding respective processes, and calls functions of other modules so as to obtain and process information, and finally manages the RFID business event.

5. The RFID BizAF as claimed in claim 1, wherein the BizAF manager module manages the RFID business event service, EPCIS capturing service, the reference specification, and information on the user, the event service generated or the reference specification registered on the RFID BizAF by the user is managed the form of a file in order to permanently maintain the information, even though a BizAF server interrupts and is executed again, the BizAF server being served as an RMI server.

6. The RFID BizAF as claimed in claim 1, wherein the BESpec includes a description in XML schema of a definition of a variable declaration, an activity part, the reference specification related on how and in what sequence the user of the BizAF communicates with a plurality of components of the EPC Network Architecture so as to obtain the information and applies business rules to the information so as to generate a real-time business event in providing the RFID business event in the RFID BizAF.

7. The RFID BizAF as claimed in claim 6, wherein the BESpec comprises a ProviderSpec for processing interactions with the RFID middleware, an EPCIS QuerySpec for processing interactions with the EPCIS, and an EPCIS CaptureSpec.

8. An RFID BizAF constructed between an application layer and an RFID middleware layer, comprising:
an event manager module for receiving a subscribe request from an application; recognizing information from a destination, transmitting a currently generated event to a final destination, and for communicating with RFID middleware for generating a business event so as to collect an RFID event in real time,
in which the RFID event received via the RFID middleware layer is combined with reference data and business rules by a BESpec so as to define the RFID business event that can be utilized by an RFID application.

9. An RFID BizAF comprising:
a BESpec for defining a process of obtaining information from at least one of RFID middleware, an EPCIS, an ONS, and an EPCIS DS of an architecture component defined in EPCNetwork in developing a real-time RFID event-based application, processing and transmitting the information, the BESpec comprising:
a variable declaration part for storing processing values in the middle of processing an activity, the activity being a basic unit of the work for generating the RFID business event,
an activity part for defining the processes that can be combined for generating the RFID business event, and
a reference specification part for defining reference information for processing in the activity.

10. The RFID BizAF as claimed in claim 9, wherein the reference specification part comprises a ProviderSpec for defining interactions with an event provider providing the real-time event,
an EPCIS QuerySpec for defining for storing history information on the RFID in the EPCIS, and
an EPCIS CaptureSpec for querying history information or unique information related on the EPC stored in an EPCIS repository.

11. The RFID BizAF as claimed in claim 10, wherein the ProviderSpec comprises ECSpec defined in an Application Level Event (ALE)Spec and a keyword in order to use a corresponding ECReport value during processing the BESpec.

12. The RFID BizAF as claimed in claim 11, wherein the keyword is used in any one form of #($reference name).($reportName).($keyword) or #($referenceName).eventTime, wherein String in ($String) means a variable.

13. The RFID BizAF as claimed in claim 9, wherein a variable type supported in the BESpec comprises a basic type of int and string, an RFID specialized type of EPC, tag, and event, and a time expression type of dateTime.

14. The RFID BizAF as claimed in claim 10, wherein the activity comprises at least one from:
a providers activity for referring to the ProviderSpec and collecting a real-time event,
an ONS activity for defining interactions with the ONS in order to obtain an address of the EPCIS having unique information,
an EPCIS DS activity for interacting with a specific EPCIS DS,
an EPCIS activity for referring to the QuerySpec and CaptureSpec so as to perform an EPCIS-related process,
a list activity for repeatedly processing,
a compute activity for supporting a computing operation for processing,
an event activity for defining generating and processing the final RFID business event using the RFID event, RFID event-related reference information, and a computed result,
a <condition> element in which a condition expression is described in order to generate the business event,
an <action> element including other activity in an inside of the <action> element if a separate process of other activity is required, and
a <dataset> element for defining to include related information, such as unique information or history information on a product in generating the business event as a result of a condition being true.

15. The RFID BizAF as claimed in claim 14, wherein the Providers activity comprises:
an <ALE> element for defining on which ProviderSpec is referred for use, and
an <within> element for defining a case where two or more <ALE> elements exist, the <within> element having a numeral value.

16. The RFID BizAF as claimed in claim 14, wherein the EPCIS activity comprises:
a <getEventData> element used for querying the history information,
a <getStaticData> element sued for querying the unique information, and
a <captureEventData> element for storing the history information in the EPCIS.

17. An RFID BizAF comprising:
an event manager module comprising a transmitting module and receiving module and for requesting and receiving an asynchronous event,
an user interface module for interacting between the RFID BizAF and a user of the RFID BizAF,
an external accessor module for communicating with an ONS and EPCIS DS,
an EPCIS accessor module for communicating with the EPCIS,
a Biz event core module for interpreting each specification, performing a corresponding work using functions of other modules, and finally generating the RFID business event or EPCIS event,
a BizAF manager module for managing a service, reference specifications, setting information on the RFID BizAF and initializing and managing another module within the BizAF, and
a Biz event dispatcher module for transmitting the RFID business event generated by the Biz event core module to an application system.

18. The RFID BizAF as claimed in claim 17, wherein the user interface module comprises:
an UserInterfaceManager for managing general flow,
a ConfigurationManager for managing information on a reference system,
a ProviderSpecManager, CaptureSpecManager, and QuerySpecMAnager for obtaining a reference specification from a ProviderSpec, an EPCIS QuerySpec, and an EPCIS CaptureSpec, respectively, and
a BusinessEventManager for obtaining a BESpec and performing start and stop of a service generating the business event.

19. The RFID BizAF as claimed in claim 18, wherein the Biz event core module comprises:
a Captureprocess for referring to information on the ProviderSpec and transmitting the ECSpec to RFID middleware using the EventManager module, and
a BizProcess including a class corresponding to a variable and an activity defined in the BESpec.

20. The RFID BizAF as claimed in claim 19, wherein, if the CaptureProcess receives an RFID event through the event manager module, the CaptureProcess refers to information on the EPCIS QuerySpec, converts the RFID event into an EPCIS event, and stores the converted EPCIS event in the EPCIS by using the EPCIS accessor module.
